(19) United States
(12) Patent Application Publication
(10) Pub. No.: US 2003/0012386 A1
(43) Pub. Date: Jan. 16, 2003

(54) Forward-secure commercial key escrow systems and escrowing methods thereof

(76) Inventors: Jeeyeon Kim, Seoul (KR); Seungjoo Kim, Seoul (KR); Hyun-Jo Kwon, Seoul (KR); Hae-Ryong Park, Kwangsan-Gu (KR); Hongsub Lee, Seoul (KR)

Correspondence Address: BIRCH STEWART KOLASCH & BIRCH, PO BOX 747, FALLS CHURCH, VA, 22040-0747, US

(21) Appl. No.: 09/997,012

(22) Filed: Nov. 30, 2001

(30) Foreign Application Priority Data
Apr. 11, 2001 (KR) 10-2001-0019279

(51) Int. Cl. H04L 9/00

(52) U.S. Cl. 380/286; 380/285

(57) ABSTRACT

The present invention discloses a software-based commercial key escrow system (KES) for the PKI environment that enables an entity such as the court to monitor communications of users suspected of unlawful activities while protecting the privacy of law-abiding users.

The present invention provides a key escrow system providing a PKI-roaming service and the perfect forward secrecy to the key management agent (KMA).

### FIELD OF THE INVENTION

The present invention relates generally to the cryptosystems and more particularly to a forward-secure commercial key escrow system that is interoperable with the PKI (Public Key Infrastructure) environment. More specifically, the present invention relates to a forward-secure commercial key escrow system that enables a given entity to monitor communications of users suspected of unlawful activities while protecting the privacy of law-abiding users.

### DESCRIPTION OF THE RELATED ART

A rapid growth of digital communication over internet have resulted in the development of information technology, Network security and particularly cryptographic technology. Cryptographic technology is widely used to ensure the privacy and authentication of messages communicated over insecure channels such as internet.

Cryptography can be used to protect the confidentiality of information by limiting access to the plain text data.

It has many advantages of using cryptography in electronic commerce and contracts over the internet for privacy and user authentication. But, the following problems may arise from the encryption key management.

First of all, a genuine user himself might not be able to access his information due to the loss or the damage of the decryption key.

Secondly, from the aspect of a company, there is a latent threat that can be caused by the misuse of the cryptosystem. For example, a rogue employee may encrypt the critical information of a company and then request money for releasing the decryption key.

Finally, from the aspect of a government, it sometimes happens that the government needs to have the right of an access to a key or plaintext with legal reasons such as the criminal investigation. Actually, the suspect can disturb the legal investigation by encrypting the information that has a relation to the crime.

The problems of the user's aspect can be solved if a commercial KES that provides services such as key-backup is used.

Furthermore, the second issue from the aspect of a company or a government can be solved if a mandatory KES is employed as a security policy.

Many countermeasures such as lawful restriction for the usage of a cryptosystem with a hidden trapdoor have been studied to prevent the cryptographic side effects. Among them the KES is a typical solution.

In general, the key escrow system can be defined as a cryptosystem that allows an authorized person to retrieve the decryption key under the pre-determined condition.

Here, the predetermined condition means user's request for the description key when a desirable KES (Key Escrow System) satisfy the opposite features between protecting user's privacy and guaranteeing law enforcement. But practically, it is not an easy task to fulfill these requirements at the same time.

As a prior art in the field of the key escrow system for the PKI environment, the KES technologies from Netscape, VeriSign, and Entrust have been disclosed. They are very popular PKI-based key escrow system. The detailed descriptions of the above-mentioned company's KES technology will be provided in the following in order to understand the shortcomings of the prior art.

First of all, let us summarize the meaning of the terminology used in the conventional KES. The user is defined as an entity using PKI-based commercial key escrow system. The registration authority, which is abbreviated as RA, is a server that registers or vouch for the identity of users to a CA that then issues certificates.

The certification authority, which is called as CA in short, is a server that manages certificates for encryption and authentication.

The key management agent (KMA), is a trusted server coordinating the key recovery agents (KRA). The KRA is a server or an administrator to provide a key recovery information to a KMA.

FIG. 1A is a schematic diagram illustrating the workflow of the Netscape's certificate management system (CMS) for a commercial key escrow system as a prior art. The detailed description of the Netscape's CMS can be found in the Netscape certificate management system administrator's guide version 4.1 (http://docs.iplanet.com/docs/manuals/cms/41/adm_guid e/contents.html).

Referring to FIG. 1A, the user 10 generates an encryption key pair (S_{A}, P_{A}). Further, the user encrypts a private key (S_{A}) with the public key (P_{KMA}) of the KMA, which is called as data recovery manager by Netscape, and sends the encrypted key E_{P}_{_{KMA}} (S_{A}) as well as the user's public key (P_{A}) to the RA 11 (step S100).

Thereafter, the RA forwards the user's encrypted key E_{P}_{_{KMA}}(S_{A}) together with the user's public key (P_{A}) to the KMA 13 for requesting the key escrow (step S101).

Now, the KMA 13 decrypts the encrypted key E_{P}_{_{KMA}} (S_{A}) with the KMA's private transport key (S_{KMA}), and checks that the user's private key (S_{A}) corresponds to the user's public key P_{A}.

Then the KMA encrypts the user's private key S_{A} with the KMA's storage key (P′_{KMA}) and stores the encrypted key in its internal database 17 (step S102 ).

Once user's private key has been successfully stored, the KMA digitally signs a token confirming that the key has been successfully stored.

The KMA's private key for storage is reserved in a software or hardware token and is protected by a PIN code.

The KMA 13 splits the PIN into n pieces with (m, n)-secret sharing scheme and then stores them encrypted with the passwords of n KRAs 14, 15, 17, respectively.

Referring to FIG. 1A again, the KMA 13 sends a digitally signed token with the KMA's private transport key to the RA 11. The signed token means that the escrow of the user's private key (S_{A}) has been successfully completed (step S104 ).

Thereafter, the RA 11 verifies the signed token and sends the certificate request to the CA 12 (step S105). The CA 12 issues and returns the encryption certificate to RA 11 (step S106), which is forwarded to the user 10 (step S107).

FIG. 1B is a schematic diagram illustrating the key recovery process from the Netscape's CMS. Referring to FIG. 1B, when the user 10 requests that KMA recover his or her private key, KMA subjects the request to its policy checks (step S120).

If the request passes all the policy rules, the KMA 13 sends a confirmation messages to n KRAs 14, 16 (step S121).

After verifying the confirmation, the KRAs then send their individual identifiers and passwords PSWD₁, PSWD₂, . . . , PSWDₙ to the KMA 13 (step S122). After the verification process of checking if the required number of KRAs send their passwords, the KMA constructs the PIN for accessing the private key repository with the passwords of KRAs.

The KMA 13 retrieves the user's encrypted private key from its key repository and decrypts it with the private component of the storage key pair. Finally, the KMA securely sends the recovered private key to the user 10 (step S123).

FIG. 2A is a schematic diagram illustrating the key escrow process of the VeriSign's Key Management Service product. More detailed information can be referred in a document “Onsite key management service administrator's guide (http://www.verisign.com)”

The feature of the VeriSign's key escrow system is that both the private key and the KMA 13 generate user's encryption key pair, which is called a key manager in the literature.

Referring to FIG. 2A, once the user 10 requests the certificate for encryption (step S130), the RA 11 forwards the request to the KMA 13 (step S131). The KMA 13 generates an encryption key pair as well as a unique triple DES key for the user.

Thereafter, the KRR (Key Recovery Record) and the KRB (Key Recovery Block) are constructed as follows.

Preferably, the KRR is constructed from the relation KRR=Eₖ(PRI), and the KRB from the relation KRB=Ε_{P}_{_{KRA}} (K) where k is a triple DES Key, and PRI is the private key of the user while P_{KRA} is the public key of the KRA 14. A KRB is the symmetric key encrypted using KRA's public key(triple DES key).

Additionally, the KMA 13 stores the created KRR and KRB in the database 17 together with the user's identifier and then the triple DES key is destroyed. Moreover, the KMA 13 sends the certificate request of the user to the CA 12 (step S133).

Consequently, the CA 12 sends the encryption certificate to the KMA 13 (step S134). Thereafter, the KMA 13 sends the private key for encryption and the certificate to the user 10 securely(step S135). Then, the KMA 13 destroys the private key of the user.

FIG. 2B is a schematic diagram illustrating the key recovery process of VeriSign's KMS product. Referring to FIG. 2B, when the user 10 requests that the KMA 13 recover his or her private key, the KMA 13 retrieves the KRB of the user from the database (step S141). Optionally, an organization may use two PINs (called “Emergency Recovery Codes”) , and thereby the level of security is enhanced from the requirement of the existence of a couple of KMA's administrators.

The retrieved KRB and the request for key recovery are transmitted to the KRA 14 (step S142). The KRA verifies if the KRB is valid and matches with two PINs. The KRA 14 then decrypts the KRB to recover the embedded triple-DES Key to decrypt the encrypted private key.

The KRA 14 returns the decrypted triple DES key to the KMA 12 (step S143). Thereafter, the KMA 13 decrypts the KRR (the encrypted private key) with the received triple DES key to recover the user's private key and then sends it to the user (step S144).

FIG. 3A is a schematic diagram illustrating the key escrow system of Entrust Corporation. The Entrust's key escrow system (KES) is described at “Administering Entrust/PKI 5.0 on UNIX”

Referring to FIG. 3A, the user sends a request for the encryption certificate to the RA 11 (step S150). The RA 11 then forwards the request to the CA 12 (step S151).

Now, the CA 12 generates the user's key pair upon the request. Furthermore, the CA 12 is responsible for the issuance of the encryption certificate.

The user 10's encryption key pair and the certificate are encrypted either with CAST-128 or with 3-DES, which are to be stored in the database 17 (step S152). In the meanwhile, the CA 12 forwards the user's private key and certificate to the user 10 via the RA 11 (step S153, S154).

FIG. 3B is a schematic diagram illustrating the key escrow process of Entrust's KES. Referring to FIG. 3B, the user requests the key recovery to the RA 11 (step S160), and then the RA 11 forwards the request to the CA 12 (step S161).

The CA 12 retrieves the encrypted private key of the user from the database 17 and decrypts the user's encrypted private key (step S162).

For the recovery of the encrypted private key at the step of S162, the passwords of the operating managers are needed and the number of operating managers participating in the recovery process of the escrowed key can be suitably chosen in accordance with the security policy.

Finally, the CA 12 forwards the decrypted private key to the user through the RA (step S163, S164).

As far as the user's privacy is concerned, the traditional commercial key escrow system proposed by either VeriSign or Entrust, however, have shortcomings in common. Namely, the user's private key for encryption is inevitably exposed to a third party at the initial step of generating a key in accordance with the prior art.

This is because anyone among the group of the user, the KMA, and the CA is capable of generating the user's key pair (including user's private key) according to the prior art.

Additionally, traditional KES (key escrow system) disclosed by VeriSign and/or Entrust is not practically applicable because the user's private key is not securely managed. For instance, the security of the user's private key relies on the KMA and/or the CA in case when either the KMA or the CA generates the user's private key.

Additionally, the KES disclosed by Netscape Corporation still has the similar problem because the KMA encrypts the user's private key with the KMA's transport key in order to verify the correspondence between the escrowed private key and the public key, which means that the user's private key is inevitably exposed to the KMA that is a third party.

Furthermore, the user's escrowed private key is encrypted with the key of the central server (for instance, the storage key of the KMA for Netscape, and CAST-128 or 3-DES key of the CA for Entrust) and stored in the database.

Even in the case of compromising the central server's long-term private key, there still exists a problem such as the reduction of the security of the user's escrowed private key.

Since KMA as a central server employs the CRS (Certificate Request Syntax) protocol in an effort to securely transmit the decrypted 3-DES key from KRM, KMA has overhead for using the CRS protocol.

In addition, the traditional commercial key escrow system still has the problem in a sense that the database is vulnerable to the concentrated attack. This is because the key is kept in a single database despite the fault tolerance due to the periodic back-ups.

### SUMMARY OF THE INVENTION

In view of the above-mentioned problems, there is a need in the art for a key escrow system, which is not subject to these limitations.

Accordingly, it is an object of the present invention to provide a practical key escrow system that is interoperable with PKI (Public Key Infrastructure).

It is another object of the present invention to provide a key escrow system supporting a PKI-roaming service in addition to the key-backup service. Here, a PKI-roaming service means that the user moving in the wireless Internet environments is able to enjoy mobile PKI-service through downloading the private key with password, which is entered anywhere at client terminal.

It is still another object of the present invention to provide a key escrow system supporting a lawful access to the user's private key. In other words, it is an object of the present invention provide a key escrow system that does not allow a third party such as the KMA or the KRA, for instance, to have an access to the user's private key for encryption without the lawful permissions like the user's recovery request or the order from the court.

Yet it is another object of the present invention to present a key escrow system that provides the perfect forward secrecy and the practical utility. Here, a server with perfect forward secrecy implies the one that does not reduce the security of the user's escrowed key despite making compromise with its long-term private key.

Practically, the server's feature of the perfect forward secrecy is a very important factor because much more information regarding the encryption key is concentrated on the central managing server.

It is also another object of the present invention to present a key escrow system that provides the blindness of the KMA or the KRA, which means that the user's private key for encryption is invisible either to the KMA or to the KRA during the key recovery process.

It is still another object of the present invention to provide the key escrow system with the fault-tolerant database of the KMA.

It is further another object of the present invention to provide a key escrow system that is possibly implemented in software. The aspect of implementation in software is important because the commercial key escrow system has to be economical even with high quality. Thus software implementation would be better for further use in e-commerce.

In general, a high-performance key escrow system is built with a hardware providing a tamperproof. However, the present invention has a feature in a sense that the escrow system is implemented in software in order to satisfy the requirement both for the cost and for the utility in electronic commerce.

Yet it is another object of the present invention to present a key escrow system providing a privacy of the user even in the case when applicable to mandatory KES. In other words, the present invention insures the user's privacy as much as possible.

It is further another object of the present invention to present a key escrow system that enhances the credibility of the user and prevents the possible attack to a single KRA. The present invention provides a new system with a feature that authorization to the key recovery should be distributed over several servers.

Yet another object of the present invention is to provide a key escrow system preventing the large-scale wiretapping.

It is suggested as a solution to enable the legal individual to wiretap only the selected users, and to prohibit illegal massive wiretapping computationally. In accordance with a broad aspect of the present invention, provided is a software-based key escrow system for the PKI environment that is beneficial to both the user and the authority.

As a result, it becomes possible to protect the user's privacy even with the extendibility to the PKI-roaming service and the practical utility in the commercial electronic applications.

### BRIEF DESCRIPTION OF THE DRAWINGS

Further features of the present invention will become apparent from a description of the fabrication process in conjunction with the accompanying drawings of the preferred embodiment of the invention, which, however, should not be taken to be limitative to the invention, but are for explanation and understanding only.

In the drawings:

FIG. 1A is a schematic diagram illustrating the key escrow process of the Netscape Corporation as a prior art.

FIG. 1B is a schematic diagram illustrating the key recovery process of the Netscape Corporation as a prior art.

FIG. 2A is a schematic diagram illustrating the key escrow process of VeriSign Corporation as a prior art.

FIG. 2B is a schematic diagram illustrating the key recovery process of Verisign Corporation as a prior art.

FIG. 3A is a schematic diagram illustrating the key escrow process of Entrust Corporation as a prior art.

FIG. 3B is a schematic diagram illustrating the key recovery process of Entrust Corporation as a prior art.

FIG. 4A is a schematic diagram illustrating the key escrow process of a first embodiment in accordance with the present invention, an RSA (n, n)-commercial KES.

FIG. 4B is a schematic diagram illustrating the key recovery process of a first embodiment in accordance with the present invention, an RSA (n, n)-commercial KES.

FIG. 5 is a schematic diagram illustrating the key escrow and recovery processes of a second embodiment in accordance with the present invention, an RSA (n, n)-mandatory KES.

FIG. 6 is a schematic diagram illustrating the key escrow and recovery processes of a third embodiment in accordance with the present invention, an RSA (n, n)-mandatory KES.

FIG. 7A is a schematic diagram illustrating the key escrow process of a fourth embodiment in accordance with the present invention, a Diffie-Hellman (n, n)-commercial KES.

FIG. 7B is a schematic diagram illustrating the key recovery process of fourth embodiment in accordance with the present invention, a Diffie-Hellman (n, n)-commercial KES.

FIG. 8 is a schematic diagram illustrating the key escrow and recovery process of a fifth embodiment in accordance with the present invention, a Diffie-Hellman (n, n)-mandatory KES.

FIG. 9 is a schematic diagram illustrating the key escrow and recovery processes of a sixth embodiment in accordance with the present invention, a Diffie-Hellman (n, n)-mandatory KES.

FIG. 10A and FIG. 10B are a schematic diagram illustrating the key escrow and recovery processes of a seventh embodiment in accordance with the present invention, a Diffie-Hellman (t, n)-commercial KES.

FIG. 11 is a schematic diagram illustrating the key escrow and recovery processes of an eighth embodiment in accordance with the present invention, a Diffie-Hellman (t, n)-mandatory KES.

FIG. 12 is a schematic diagram illustrating the key escrow and recovery processes of a ninth embodiment in accordance with the present invention, a Diffie-Hellman (t, n)-mandatory KES.

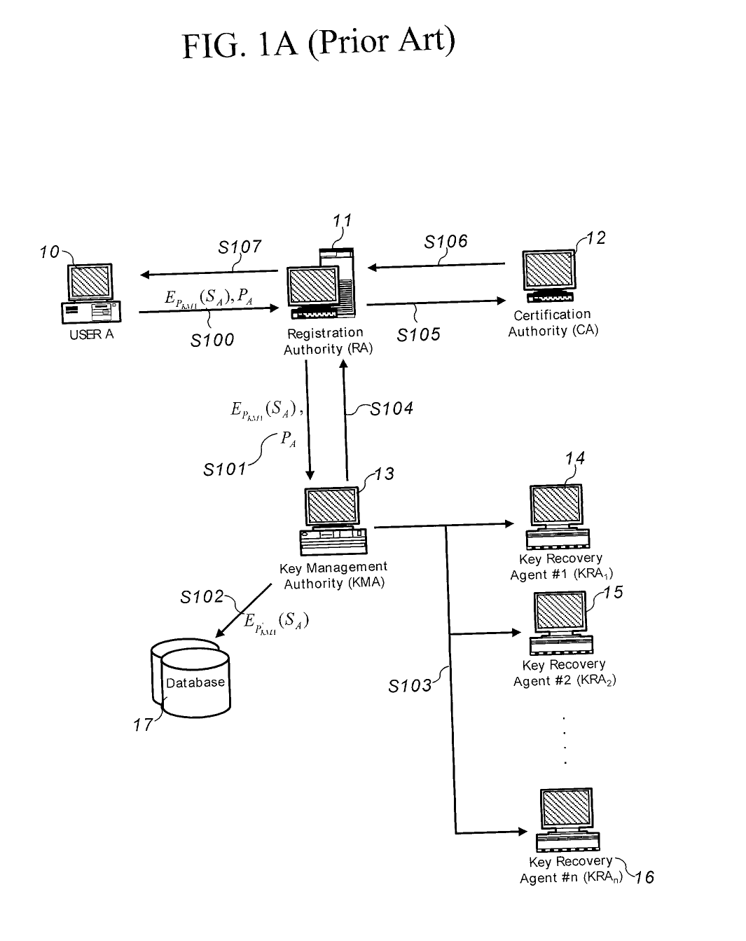

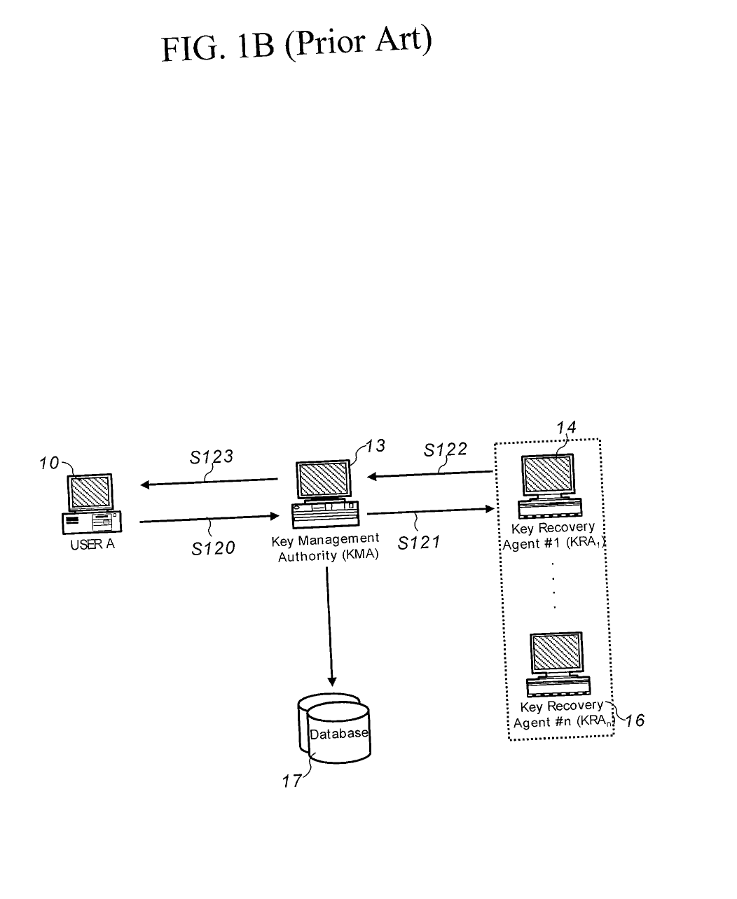

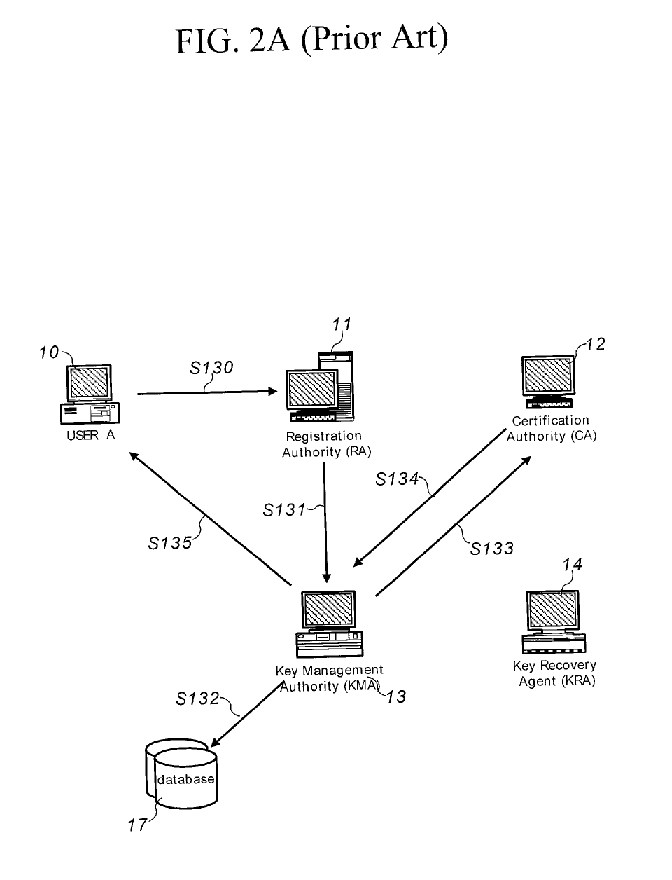

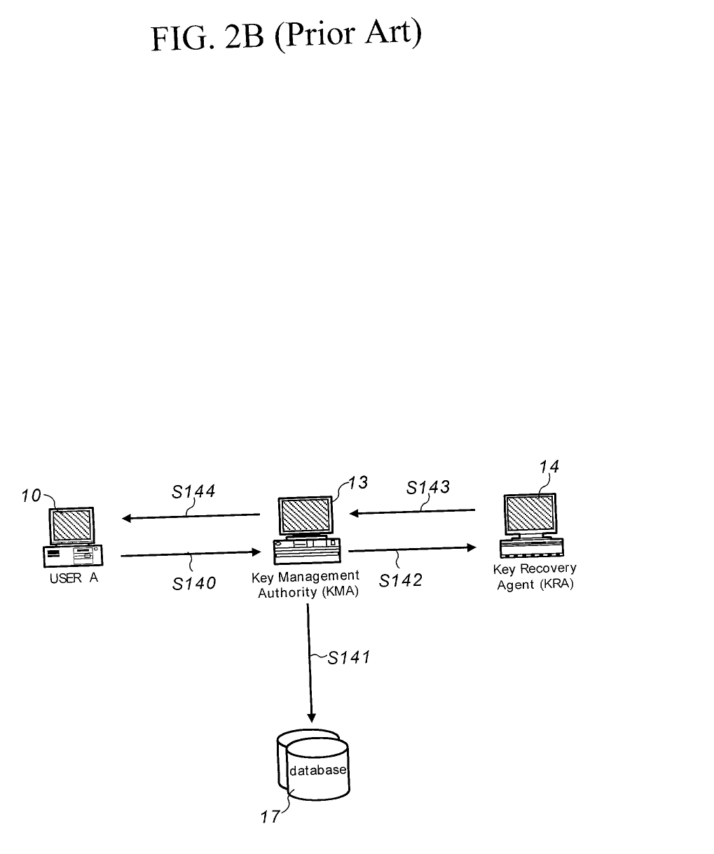

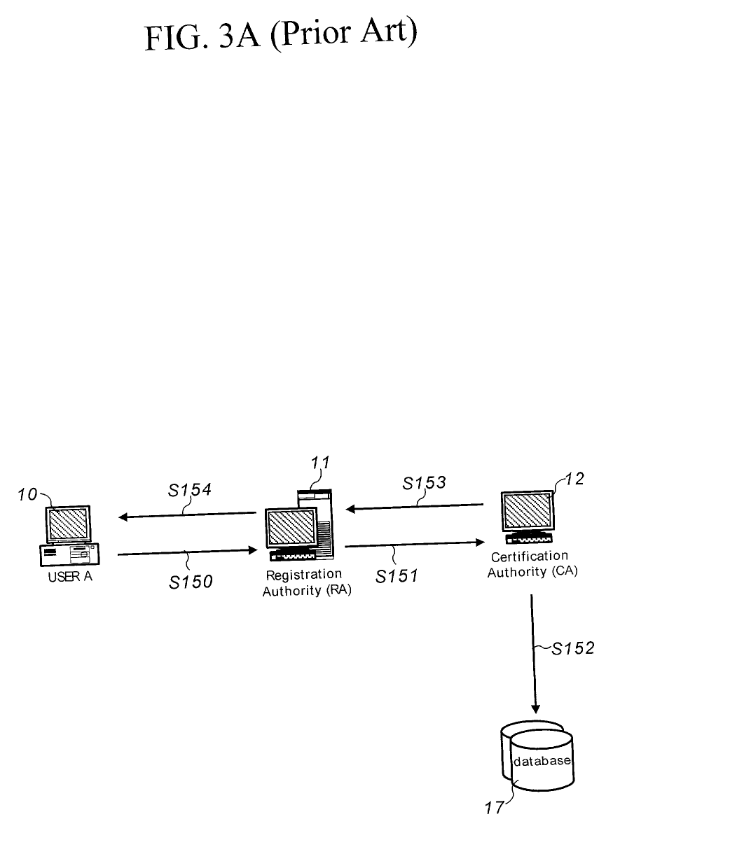

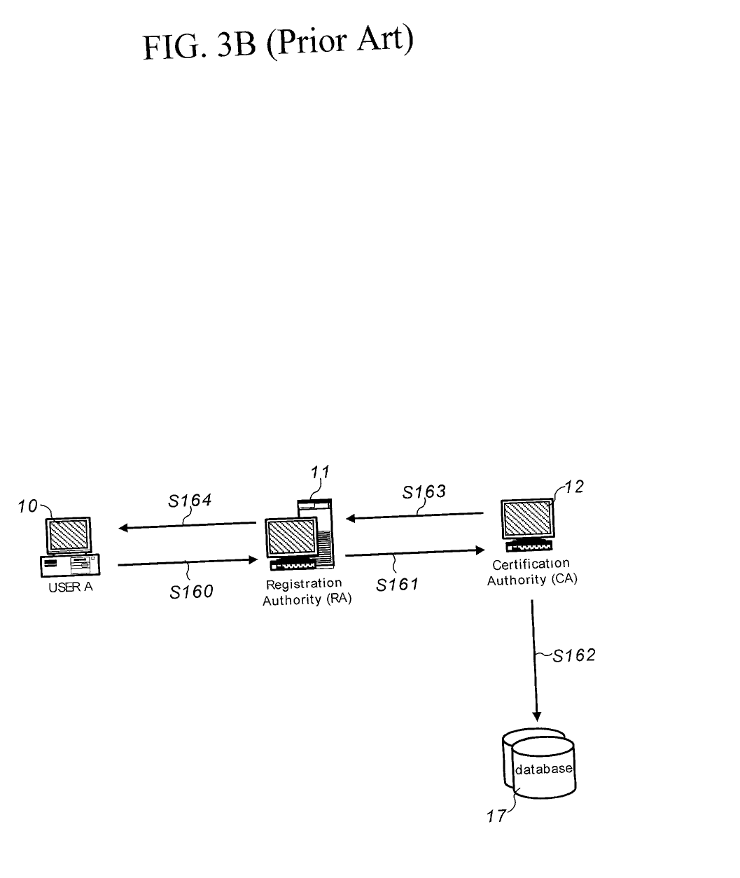

### DETAILED DESCRIPTION OF THE INVENTION

The present invention will be explained in detail with reference to the accompanying drawings.

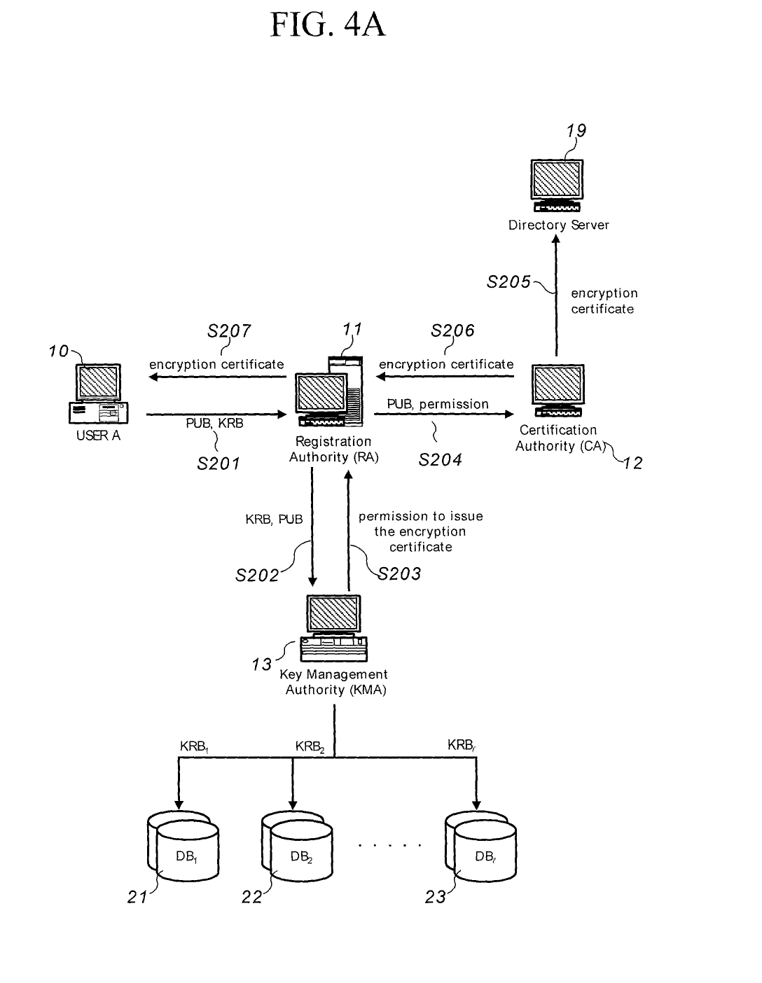

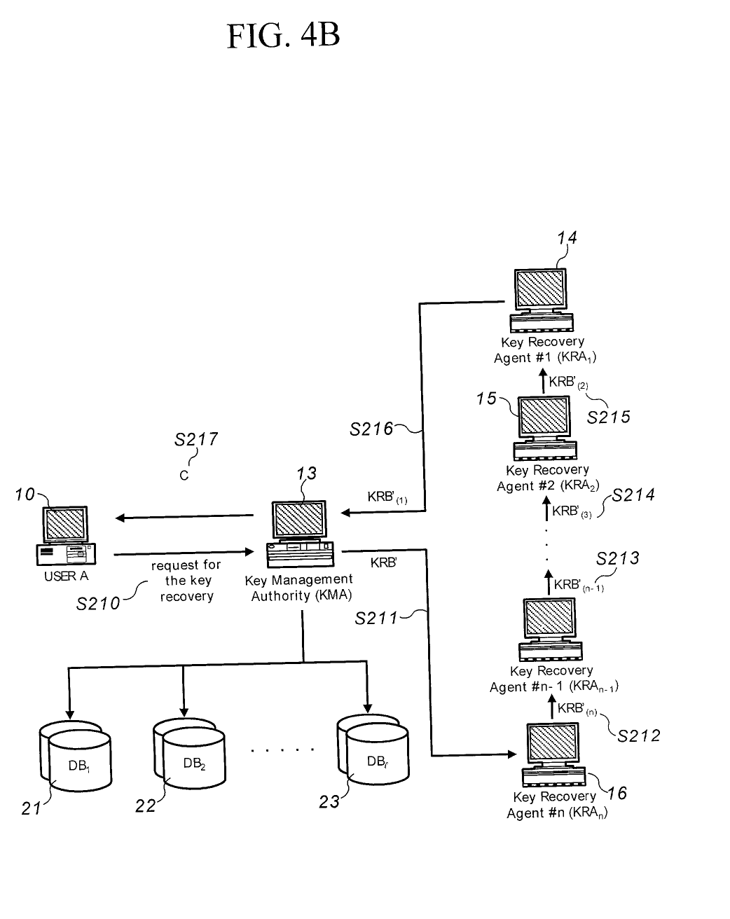

Shown in FIG. 4A and FIG. 4B are the schematic representations of the key escrow and recovery process of a first embodiment in accordance with the present invention, an RSA (n, n)-commercial KES, respectively.

For the understanding of the features of the present invention, let us explain the notations used in the following context

PWD: user's password, which is supposed to be memorized, for the PKI-roaming service

VER: user's password verifier that is registered in the KMA.

KRB: user's key recovery block.

(e₁, Nᵢ): the public key of the KRAᵢ for encryption (N₁<N₂< . . . <N₁< . . . <Nₙ)

d₁: the private key of the KRA₁ for decryption.

Referring to FIG. 4A, the user 10 generates a pair of private/public keys (PRI, PUB) for encryption. The KRB (key recovery block) is constructed by the user and then forwarded to the RA 11 along with the PUB (step S201).

The present invention has a feature that the user himself encrypts PRI with PWD. In other words, the operation of C=E_{PWD}(PRI) is performed by the user.

KRB=( . . . ((C^{e}^{₁}modN₁)^{e}^{₂}modN₂) . . . )^{e}^{ₙ}modNₙ (1)

Referring to FIG. 4A again, the RA 11 sends the KRB and PUB to the KMA 13 (step S202). In the meanwhile, the KMA divides the key recovery block into l shares (KRB₁, KRB₂, . . . , KRBₗ) with (m, l)-SS (m<l) and stores each share with the user's identifier in the associate l databases 23 (DB₁, DB₂, . . . , DBₗ) , correspondingly.

Preferably, the KRB is then destroyed as long as the divided shares are stored in each database in an appropriate manner. Thereafter, the KMA 13 sends the notice permitting the issuance of encryption certificate to the RA 11 (step S203).

The RA 11 then exhibits the permission for the issuance to the CA 12 and requests an encryption certificate for the public key of the user 10 (step S204).

Accordingly, the CA 12 issues encryption certificate (step S205) and sends it to the RA 11 (step S206). Further, the CA 12 opens an encryption certificate in the directory server 19. Finally, the RA 11 forwards the encryption certificate to the user 10 (step S207).

FIG. 4B is a schematic diagram illustrating the key recovery process of a first embodiment in accordance with the present invention, an RSA (n, n)-commercial KES. Referring to FIG. 4B, the user 10 sends a request for the recovery of the private key for encryption to the KMA 13 (step S210).

After completing the step of identifying the user 10, the KMA 13 retrieves m key recovery blocks (KRB₁, KRB₂, . . . , KRBₘ) out of l KRB₁ and reconstructs KRB through the (m, l)-SS. As a preferred embodiment in accordance with the present invention, the encrypted private key E_{PWD}(PRI) is recovered by the KMA 13 through the following steps.

The KMA 13 randomly chooses a blind factor r (0<r<N₁) and calculates KRB′ from the relationship of

KRB′=KRB·( . . . (r^{e}^{₁}modN₁)^{e}^{₂}modN₂) . . . )^{e}^{ₙ}modNₙ.

Now, the KMA 13 sends the KRB′ along with the request for the key recovery to the n-th key recovery server KRAₙ (step S211). In a reverse order from the n-th KRA to the first KRA (KRAₙ, KRAₙ₋₁, . . . , KRA₁) , each KRAᵢ decrypts the received message with its own private key (step S212 through to S216).

KRAₙ:KRB′₍ₙ₎=(KRB′)^{d}^{ₙ}modNₙ (2)

KRAₙ₋₁:KRB′₍ₙ₋₁)=(KRB′₍ₙ₎)^{d}^{ₙ₋₁}modNₙ₋₁ (3)

$$\begin{matrix}{KRA}_{n} : {KRB}_{( n )}^{′} = {( {KRB}^{′} )}^{{d}_{n}} mod {N}_{n} & ( 2 ) \\ {KRA}_{n - 1} : {KRB}_{( n - 1 )}^{′} = {( {KRB}_{( n )}^{′} )}^{{d}_{n - 1}} mod {N}_{n - 1} \\ ⋮ & ( 3 ) \\ {KRA}_{2} : {KRB}_{( 2 )}^{′} = {( {KRB}_{( 3 )}^{′} )}^{{d}_{2}} mod {N}_{2} & ( 4 ) \\ {KRA}_{1} : {KRB}_{( 1 )}^{′} = {( {KRB}_{( 2 )}^{′} )}^{{d}_{1}} mod {N}_{1} \\ = {E}_{P W D} ( P R I ) \cdot r mod {N}_{1} & ( 5 )\end{matrix}$$

The KRA₁ sends the KRB′₍₁₎=E_{PWD}(PRI)·r modN₁ to the KMA. Finally, the KMA 13 recovers C=E_{PWD}(PRI)=KRB′₍₁₎/r modN₁.

More preferably, the KMA 13 that has the password verifier (VER) of the user 10 sends C=E_{PWD}(PRI) to the user in a secure fashion such as the password-based private key downloading protocol (step S217).

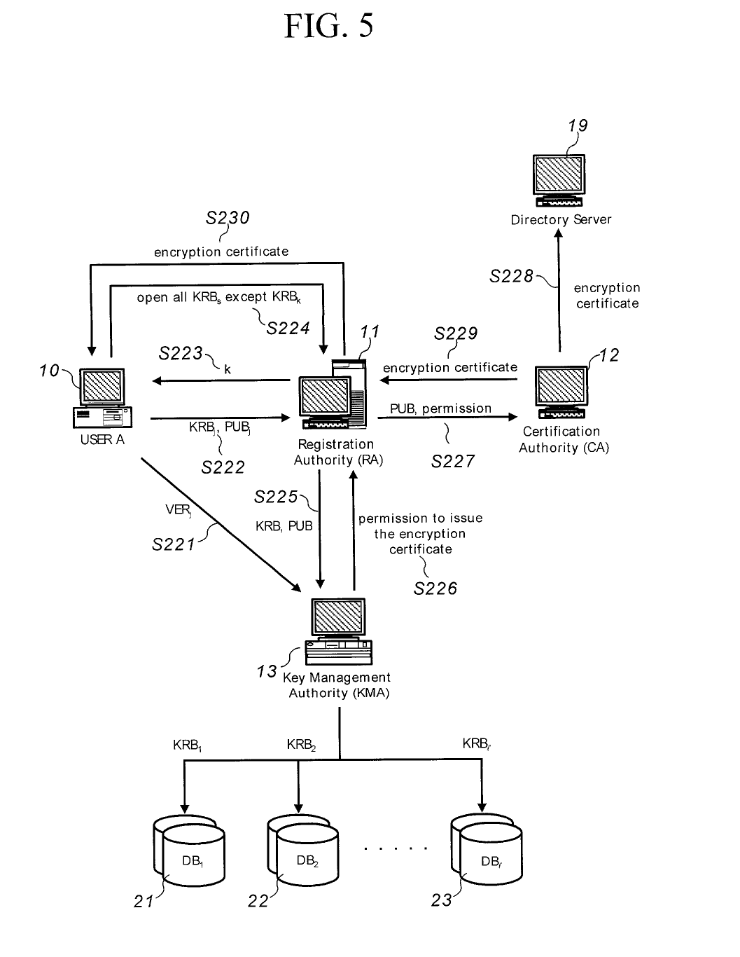

FIG. 5 is a schematic representation illustrating the key escrow process of a second embodiment in accordance with the present invention, an RSA (n, n)-mandatory KES. For a mandatory KES of a second embodiment in accordance with the present invention, the RA has to check if the escrowed private key of the user for encryption has a correspondence to the public key of the user.

The second embodiment of the present invention discloses a technique that protects the privacy of the user simultaneously with checking capability of the validity of the key recovery block from the user.

Referring to FIG. 5, the user 10 generates a total of s passwords PWDⱼ (j=1, . . . , s) and registers the s password verifiers VERⱼ corresponding to each password to the KMA 13 (step S221).

Now, the user generates s pairs of private/public keys for encryption (PRI_{J}, PUBⱼ) In other words, the user 10 generates a set of s private keys (PRI₁, PRI₂, . . . , PRI_{S}) and a set of public keys (PUB₁, PUB₂, . . . PUB_{S}). Thereafter the set of s private keys PRIⱼ is encrypted with a set of password PWDⱼ of the user (j=1, . . . , s).

In other words, C_{J}=E_{PWD}_{_{J}}(PRI_{J}) (j=1, . . . , s) is calculated. In this case, the encrypting step with PWD can be skipped preferably during the process of constructing the KRB when applicable to the key escrow system for the urgent wiretapping.

Now, the user constructs s key recovery blocks with a relationship of KRB_{J}=( . . . ((Cⱼ^{e}^{₁} modN₁)^{e}^{₂}modN₂) . . . )^{e}^{ₙ}modNₙ and sends them along with the public keys PUBⱼ (j=1, . . . , s) to the RA 11 (step S222).

The RA 11 that has received the KRBⱼ (j=1, . . . , s) and PUB_{J} (j=1, . . . , s) sends a random number of k 1≦k≦s to the user (step S223).

The user 10 opens (s−1) KRB except KRBₖ to RA 11. In other words, the password PWD_{J} and PRIⱼ ∀j≈k, 1≦k≦s are sent to the RA 11 (step S224).

As a preferred embodiment in accordance with the present invention, the number s controls the strength of the security. More preferably, this scheme can be designed in such a way as a non-interactive KES with a hash function.

Further, the RA 11 that has received (s−1) KRBⱼ except KRAₖ examines the validity of PRI_{J} and PUBⱼ with the following equation.

KRB_{J}?( . . . ((Cⱼ^{e}^{₁}modN₁)^{e}^{₂}modN₂) . . . )^{e}^{ₙ}mod Nₙ (6)

where ∀j≈k, 1≧j≧s.

Once the validity of the one-to-one correspondence between the PRIⱼ, PUBⱼ, and KRBⱼ ∀j≈k, 1≧j≧s is checked, it is considered that it is still valid even when j=k. Then, the RA 11 sends the KRB=KRBₖ, and PUB=PUBₖ to the KMA 13 (step S225). The remaining steps S226 through to S230 are identical to the processes of the first embodiment.

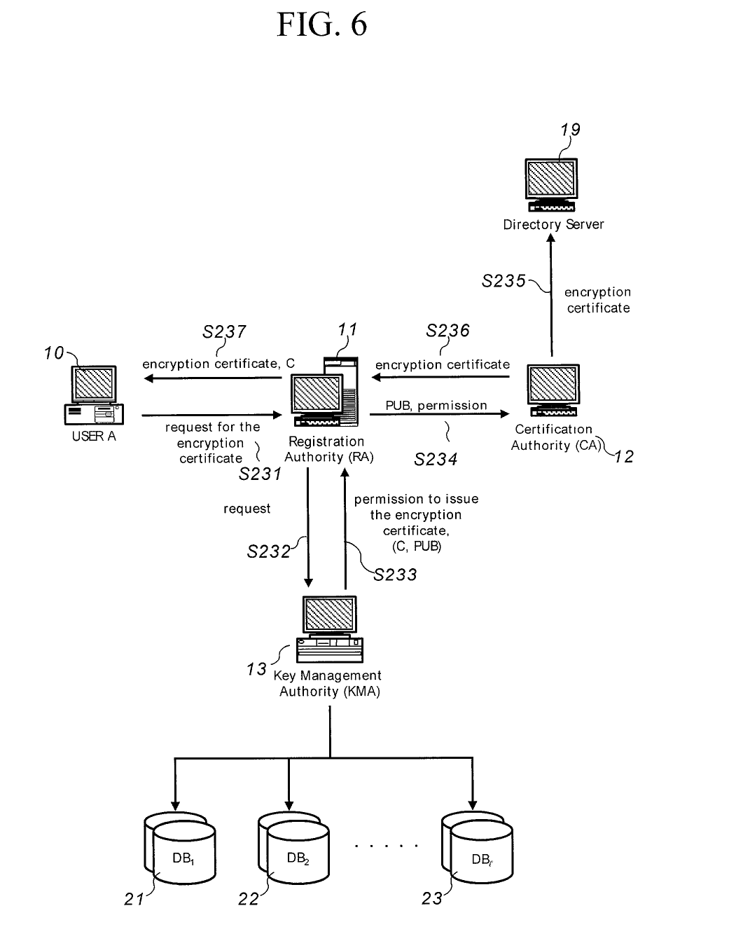

FIG. 6 is a schematic diagram illustrating the key escrowing process of a third embodiment in accordance with the present invention, an RAS (n, n)-mandatory KES.

The third embodiment discloses a key escrow system wherein the private/public keys of the user are generated by the KMA 13, and encrypted with PWD of the user for transmitting to the user.

The third embodiment can be employed for the practical, safe, and robust key escrow system against shadow attack.

Referring to FIG. 6, the user 10 sends a request for encryption certificate to the RA 11 (step S231). Then the request is forwarded to the KMA 13 (step S232) through the RA 11.

In the meanwhile, the KMA 13 constructs a pair of the user's private/public keys (PRI, PUB) for encryption. The KRB is constructed and stored in the database as illustrated in the following description.

First of all, the KMA 13 encrypts the user's private key PRI with password PWD. In other words, the operation of C=E_{PWD}(PRI) is performed, followed by a step of destroying the PRI. Now, the KRB is calculated with the following equation.

KRB=( . . . ((C^{e}^{₁}modN₁)^{e}^{₂}modN₂) . . . )^{e}^{ₙ}modNₙ (7)

Additionally, the KMA 13 divides the KRB into l shares with (m, l)-SS (m<l) and stores each share (KRB₁, KRB₂, . . . , KRBₗ) along with the user's identifier in the l databases, DB₁ 21, DB₂ 22, . . . , DBₗ 23, respectively.

AS a preferred embodiment, the KRB is destroyed, after storing KRB₁ in the database. The KMA 13 sends the notice permitting the issuance of encryption certificate along with (C, PUB) to the RA 11 (step S233).

The RA 11 then presents the permission to the CA 12 for the issuance and requests a encryption certificate for the public key PUB of the user 10 for encryption (step S234).

Accordingly, the CA 12 issues the encryption certificate (step S235) and sends it to the RA 11 (step S236). Further, the CA 12 open an encryption certificate in the directory server 19.

Finally, the RA 11 forwards the certificate to the user 10 (step S237). The escrowed private key of the user in the mandatory KES can be recovered through the process illustrated in FIG. 4B, and the KMA should mount a dictionary attack to recover the private key PRI of the user for encryption.

Now, let us review the features of the present invention with comparison to the prior art by referring to the following table.

TABLE 1
Comparison of features invention
and prior art

| | | Netscape | Verisign | Entrust | |
|---|---|---|---|---|---|
| | | (Prior | (Prior | (Prior | |
| | | Art) | Art) | Art) | Invention |
| Commer- | Lawful | Poor | Poor | Poor | Excellent |
| cial | Access | | | | |
| KES | Utility and | Poor | Poor | Poor | Excellent |
| | Perfect | | | | |
| | forward | | | | |
| | secrecy | | | | |
| | Blindness | Poor | Poor | Poor | Excellent |
| | Fault | Good | Good | Good | Excellent |
| | Tolerance of | | | | |
| | storage unit | | | | |
| | Feasibility | Excellent | Excellent | Excellent | Excellent |
| | with | | | | |
| | software | | | | |
| | Value-Added | N/A | PKI- | PKI- | PKI- |
| | service | | roaming | roaming | roaming |
| | | | service | service | service |
| Mandatory | Division of | Good | Good | Good | Excellent |
| KES | authority | | | depending | |
| | for key | | | on | |
| | recovery | | | Security | |
| | | | | Policy) | |
| | Large-scale | Poor | Poor | Poor | Excellent |
| | wiretapping | | | | |

The present invention has a unique feature of lawful access because the private key of the user for encryption is encrypted with password PWD that is privately kept only to the user and then encrypted with the KRA's public key in a successive manner for transmittance.

Moreover, since the second embodiment in accordance with the present invention, an RSA (n, n)-mandatory KES, preferably employs the cut & choose method for checking the validity of the escrowed private key of the user, a lawful access is guaranteed due to the fact that the secret KRB that has not been made open to a third party is sent to the KMA.

In the meanwhile, the prior art disclosed by VeriSign and Entrust corporations has a limitation in that the private key of the user can be exposed either to the KMA or to the CA during the generating and escrowing phase, not the recovering phase, because the KMA or the CA itself generates the private key of the user.

Furthermore, the prior art even from Netscape Corporation discloses a key escrow system wherein the private key of the user is encrypted with a key for transport of the KMA in order to examine the correspondence between the private key and the public key.

Therefore, it may happen that the private key of the user is exposed to the KMA during the generating and escrowing phase rather than the recovering phase.

Referring to the Table 1, the present invention has an overwhelming feature in terms of the utility and perfect forward secrecy. For instance, the prior art disclosed from Netscape and Entrust has a shortcoming in a sense that the escrowed key of the user is encrypted with the key of the server (i.e., DRM's storage key in Netscape and CA's CAST-128 key or triple DES key in Entrust) and once the private key of the server is made open to the public, the private key of the user for encryption will be in danger.

Moreover, the prior art disclosed from VeriSign Corporation still has a limitation because the key for the CRS protocol, which is employed for the encryption of the transmitted message, should kept in a secure fashion in order for the KMA to forward the decrypted 3-DES key to the KRA.

In the meanwhile, the present invention provides a technique that makes it possible to guarantee a perfect forward secrecy because it is not necessary for the KMA to administrate the extra private and public keys.

Moreover, it is not possible for the KMA to figure out the private key of the user either during the key generation and escrowing phase or during the key recovering phase since the private key of the user is encrypted with the user's own password that the KMA doesn't know.

Furthermore, the blind decoding algorithm in accordance with the present invention does not allow any KRA to find out the information of the user's private key during the recovering step of the key.

The key escrow system in accordance with the present invention has further a feature of fault tolerance of the storage unit.

The periodic back-ups of the database in the prior art disclosed by Netscape, VeriSign, and Entrust still does not provide a fault tolerance since a single unit of database is vulnerable to the hacker's attack.

To the contrary, the KMA in accordance with the present invention divides the KRB into a number of shares and each piece of KRB is separately stored in the multiple units of database.

Therefore, it becomes possible to decrease the chance of being attacked by a hacker for the preferred embodiments in accordance with the present invention.

More preferably, the proactive secure algorithm allows the security of the KES in accordance with the present invention to be enhanced.

For the reader's reference, the proactive secure algorithm can be referred in a paper titled “How to withstand mobile virus attacks,” by R. Ostrovski and M. Young, pp. 51-61, 10th ACM symposium proceeding, 1991.

In addition, the present invention has a feature of flexibility for implementation both in software and in hardware. The present invention also provides enough flexibility regardless of the platform when compared to the prior art like Clipper.

The technology for the Clipper is described in a paper titled with, “Escrow encryption Standard (EES),” FIBS PUB (federal information processing standards publication) published by NIST, 1994.

Referring to Table 1 again, the present invention has a feature of providing a PKI-roaming service due to the fact that the recovered key C=E_{PWD}(PRI) is supposed to be transmitted to the user in a secure manner through the password-based private key downloading protocol.

Additionally, the key escrow system in accordance with the present invention, unlike the prior art such as the VeriSign's system, prevents the KRA from abusing its authorized power since the authorization for the key recovery is shared by many KRAs.

Furthermore, the present invention has a feature of preventing a large-scale wiretapping since the KMA recovers the private key of the user through the dictionary attack as in the partial KES.

More preferably, the speed of the recovery process of the key can be enhanced through employing the technique disclosed in the U.S. patent application Ser. No. 76/193,977 (High-speed RSA public key cryptographic method).

In general, the sender and the receiver make an agreement on their session key by Diffie-Hellman key exchange protocol. Once the user's long-term private key is disclosed, all the communications are insecure.

Therefore, the limitation of the period of the wiretapping becomes an important issue for the recovery of the key.

One approach to resolve the above-mentioned problem is to employ a protocol of distributing the session key suggested by A. K. Lenstra. Detailed description about the protocol of distributing the session key can be found in a literature “A key escrow system with warrant bounds,” pp. 197-207 of a book titled with “Advances in cryptology-crypto 95 published by Springer-Verlag, 1995”.

Now, the followings are the description about additional embodiments in accordance with the present invention, a Diffie-Hellman KES.

First of all, let us explain the notations used in the following context.

PWD: the user's password for PKI-roaming service, which is supposed to be memorized.

p: prime, P=qw+1, where q is a large prime and w is a smooth composite.

q: a generator of G_{q}, where G_{q} is the unique subgroup of Zₚ* of order q.

(X₁, Yᵢ) the KRA₁'s pair of encryption key, where yᵢ=g^{X}^{₁}modp.

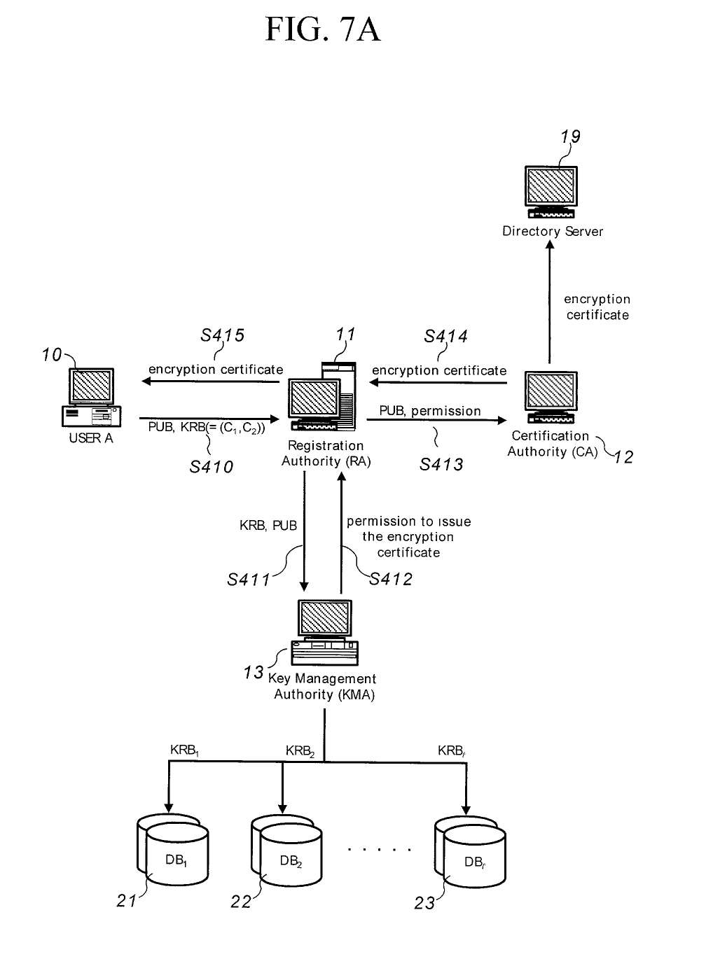

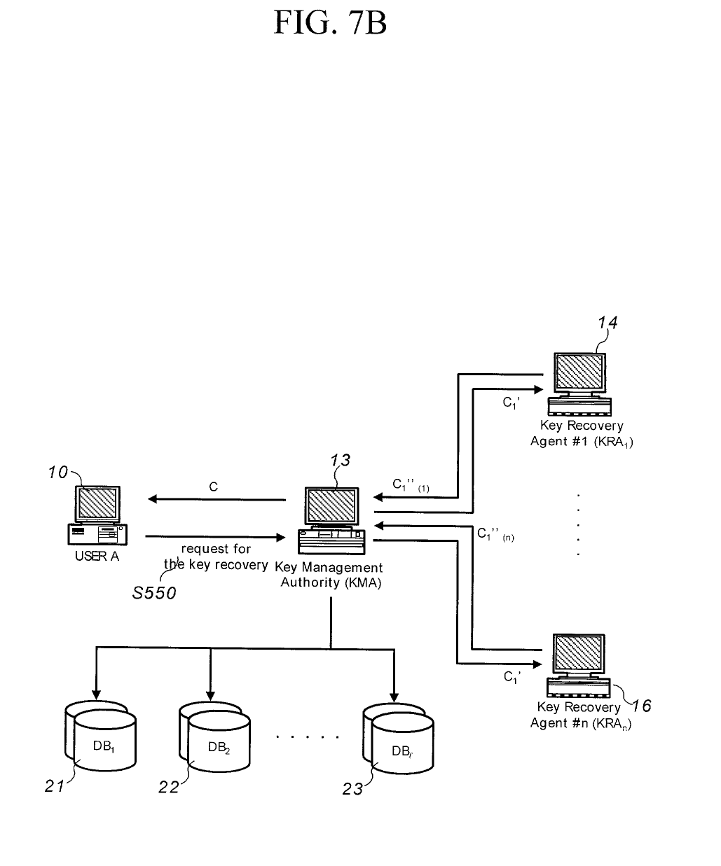

FIG. 7A is a schematic representation illustrating the generating and escrowing process of the key of a fourth embodiment in accordance with the present invention, a Diffie-Hellman (n, n)-commercial KES.

Referring to FIG. 7A, the user 10 generates a pair of private/public keys (PRI, PUB) and transmits the KRB along with the PUB to the RA 11 (step S410).

Here, the user encrypts his private key PRI with his own password PWD. In other words, the user generates C with a relation of C=E_{PWD}(PRI).

Thereafter, the user selects a random number z from the range 0<z<q. Moreover, the KRB is constructed from the following equation.

KRB=(C₁, C₂)=(g^{z}modP, C·(y₁·y₂· . . . ·yₙ)^{z}modP (8)

In the meanwhile, the RA 11 transmits the KRB and PUB to the KMA 13 (step S411). Additionally, the KMA divides the KRB into l share (KRB₁, KRB₂, . . . , KRBₗ) with (m,l)-ss (m<l) and stores each share with the user's identifier in each database (DB₁ 21, DB₂ 22, . . . , DBₗ 23). After completing the storage, the KRB is destroyed.

The KMA 13 then sends the notice permitting the issuance of encryption certificate along with (C, PUB) to the RA 11 (step S412).

The RA 11 then presents the permission to the CA 12 for the issuance and requests a certificate for the user's public key PUB (step S413).

Accordingly, the CA 12 issues encryption certificate and open an encryption certificate in the directory server 19.

The CA 12 sends the certificate to the RA 11 (step S414). Finally, the RA 11 forwards the certificate to the user 10 (step S237).

FIG. 7B is a schematic diagram illustrating the recovering process of the key of a fourth embodiment in accordance with the present invention, a Diffie-Hellman (n, n)-commercial KES.

Referring to FIG. 7B, the user 10 sends a request for the recovery of the private key for encryption to the KMA 13 (step S550).

After completing the step of identifying the user 10, the KMA 13 retrieves m key recovery blocks (KRB₁, KRB₂, . . . , KRBₘ) out of l KRBᵢ and reconstructs the KRB through the (m, l)-SS (m<l).

As a preferred embodiment in accordance with the present invention, the encrypted private key E_{PWD}(PRI) is recovered by the KMA 13 through the following steps.

The KMA 13 randomly chooses a blind factor r (0<r<P−1) and calculates C₁′ from the relation of C₁′=C₁^{r}modp.

Thereafter, the KMA 13 sends the calculated C₁′ along with a request for the recovery of the private key to the key recovery agents (KRA₁, KRA₂, KRAₙ) .

In addition, each KRAᵢ calculates C₁″₍₁₎=(C₁′)^{x}^{₋}modP and then sends C₁″₍ᵢ₎ to the KMA 13 (i=1, . . . , n).

The KMA 13 recovers the key C=E_{PWD}(PRI) by calculating C₂/(C₁″₍₁₎·C₁″₍₂₎· . . . ·C₁″₍ₙ₎)^{1/r}modP. Finally, the KMA 13, which has a password verifier of the user 10, sends the recovered private key C=E_{PWD}(PRI) to the user in a secure fashion such as the password-based private key downloading protocol.

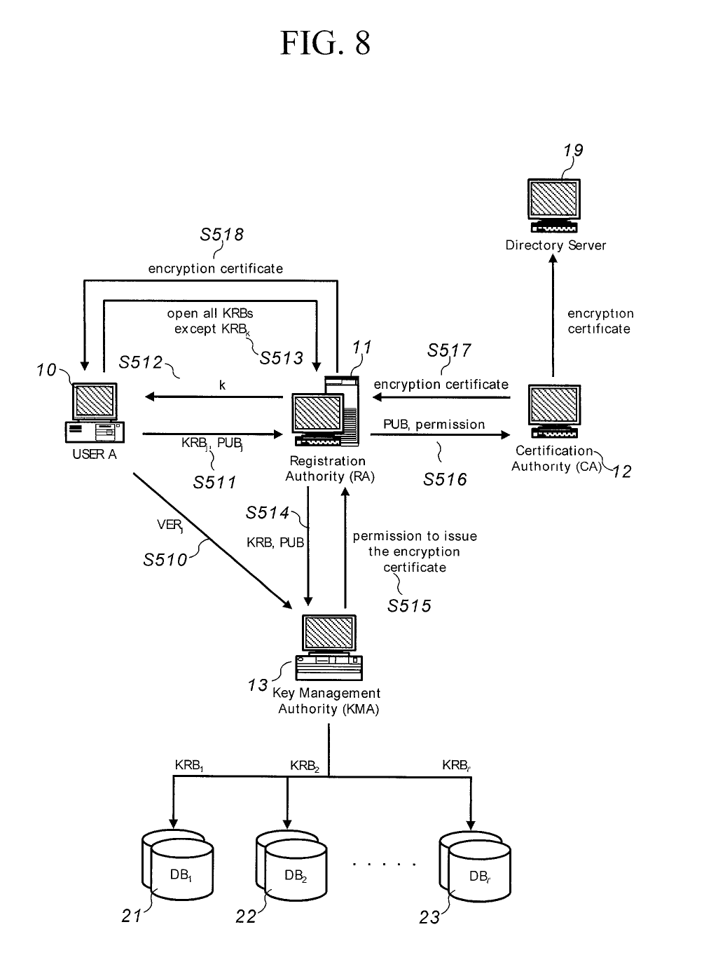

FIG. 8 is a schematic diagram illustrating the generating and escrowing process of a fifth embodiment in accordance with the present invention, a Diffie-Hellman (n, n)-mandatory KES.

For a mandatory KES of a fifth embodiment in accordance with the present invention, the RA performs an additional step of checking the validity of the escrowed KRB.

Referring to FIG. 8, the user 10 generates a total of s passwords PWDⱼ (j=1, . . . , s) and registers the s password verifiers VERⱼ corresponding to each password to the KMA 13 (step S510).

Now, the user generates a total of s pairs of private/public keys for encryption (PRIⱼ, PUBⱼ). In other words, a set of s private keys (PRI₁, PRI₂, . . . , PRI_{S}) and a set of s public keys (PUB₁, PUB₂, . . . , PUBₛ) are generated by the user 10.

Thereafter, a set of KRBⱼ (j=1, . . . , s) is constructed and sent to the RA 11 along with PUBⱼ (j=1, . . . , s). The private key PRIⱼ is encrypted with the password PWDⱼ of the user himself 10. In other words, C_{J}=E_{PWD}_{ⱼ} (PRI (j=1, . . . , s) is calculated.

Preferably, in the key escrow system that needs the urgent wiretapping, the encrypting step with PWD can be skipped during the generating step of the KRB. Additionally, a total of s random numbers z₁ are chosen in a range of 0<zᵢ<q (j=1, . . . , s) and the KRBⱼ (j=1, . . . , s) is calculated from the following equation.

$$\begin{matrix}{KRB}_{j} = ( {C}_{1 j} , {C}_{{2}_{3}} ) \\ = ( {g}^{{z}_{j}} mod P , {C}_{j} \cdot {( {y}_{1} \cdot {y}_{2} \cdot … \cdot {y}_{n} )}^{{z}_{3}} mod P\end{matrix} \qquad ( 9 )$$

In the meanwhile, the RA 11 chooses k randomly in a range of 1≦k≦s and sends k to the user (step S512). Preferably, the security level of the system can be varied with s.

Referring to FIG. 8 again, the user 10 open (s−1) KRBⱼ except the KRBₖ to RA 11 (step S513). In other words, the password PWDⱼ, PRIⱼ and zⱼ ∀j≈k, 1≦j≦s are sent to the RA 11. Further, the RA 11, which has received (s−1) KRBₛ except the KRBₖ, examines the validity and the correspondence of PRIⱼ, PUB_{J}, and KRB_{J} with the following equation.

KRB_{J}?(g^{z}^{_{J}}modP, C_{J}·(y₁·y₂· . . . ·yₙ)^{z}^{_{J}}modP (10)

As a preferred embodiment in accordance with the present invention, the number S controls the strength of the security. More preferably, this scheme can be designed in such a way as a non-interactive KES with a hash function. Now the RA 11 sends KRB=KRBₖ and PUB=PUBₖ to the KMA 13 (step S514). The remaining steps S515 through to S518 are identical to the processes of the fourth embodiment.

The Sixth embodiment can be employed for the practical, safe, and robust key escrow system against shadow attack.

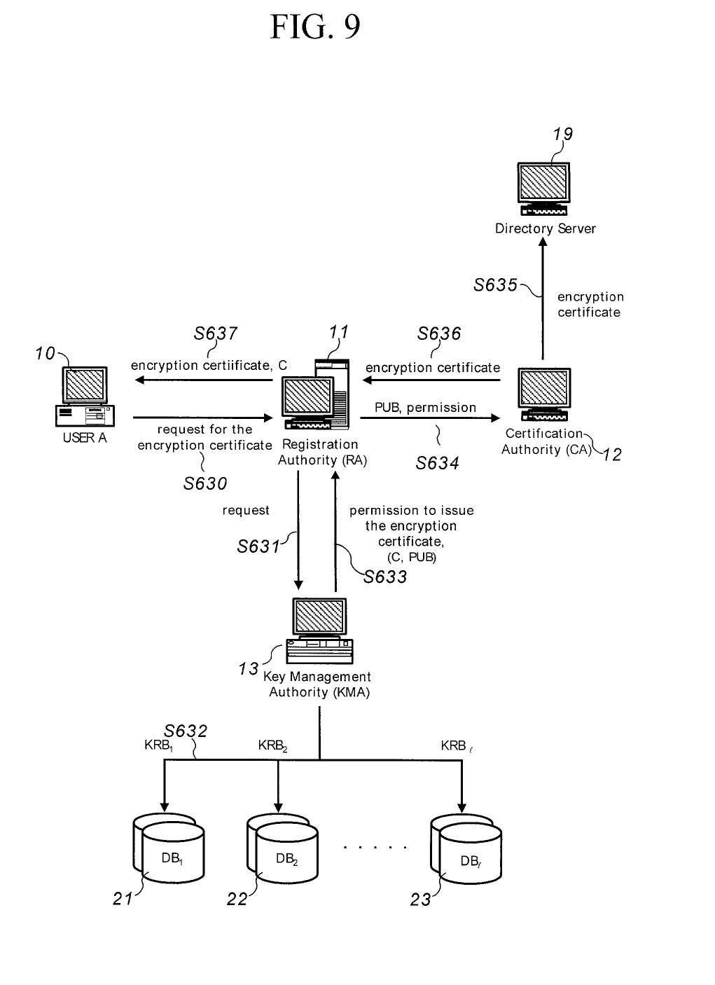

FIG. 9 is a schematic diagram illustrating the generating and escrowing process of a sixth embodiment in accordance with the present invention, a (n, n)-mandatory KES based on Diffie-Hellman.

Referring to FIG. 9, the user 10 sends a request for an encryption certificate to the RA 11 (step S630). The RA 11 forwards the request to the KMA 13 (step S631). The KMA 13 generates a pair of private/public keys (PRI, PUB), and constructs the KRB to store in a distributed database 21, 22, 23 (step S632).

The KMA 13 encrypts the user's private key PRI with user's password PWD. In other words, C=E_{PWD}(PRI) is calculated. In this case, it is assumed that the password of the user 10 PWD has been pre-registered at the KMA 13.

Thereafter, a random number z is selected in the range of 0<z<q. The KRB is constructed from the following equation.

KRB=(C₁, C₂)=(g^{z}modP, C·(y₁·y₂· . . . ·yₙ)^{z}modp (11)

Now, the KMA 13 divides the KRB into l shares (KRB₁, KRB₂, . . . , KRBₗ) with (m, l)-SS (m<l), and stores each share in the associated database (DB₁, DB₂, . . . , DBₗ) of l, correspondingly, with the identifier of the user. After storing KRB₁ in the database, the KRB is destroyed.

The KMA 13 then sends the permission to issue the encryption certificate along with (C, PUB) to the RA 11 (step S633). The RA 11 then presents the permission to the CA 12 and requests a certificate for the public key of the user 10, PUB (step S634).

Accordingly, the CA 12 issues the certificate of encryption and makes it public at a directory server 19 (step S635). The CA 12 sends the certificate to the RA 11 (step S636). Finally, the RA 11 forwards the certificate to the user 10 (step S637).

For the fifth embodiment of this invention, the escrowed key can be recovered with the process depicted in FIG. 7B. In this case, the KMA can recover the private key of the user, PRI, by mounting a dictionary attack on the password of the user.

For the sixth embodiment of the present invention, the escrowed key can also be recovered with the process in FIG. 7B. In this case, the KMA can recover the private key of the user, PRI, by using the password available to the KMA.

Now, the following is a detailed description of another embodiment of this invention, (t, n)-commercial KES based on Diffie-Hellman (t<n). The unique feature of the preferred Diffie-Hellman (t, n)-commercial embodiment in accordance with the present invention is that t KRAs out of n are enough for the recovery of the escrowed key.

x₁: a private key of KRA₁ for 1≦i≦n.

y: a public key of the group of KRAs.

P: a prime, P=qw+1, where q is a large prime and w is a smooth composite.

g: a generator of G_{q}, where G_{q} is the unique subgroup of Zₚ^{*} of order q.

Each KRAᵢ=1, . . . , n chooses r₁ε_{R}z_{q} and makes y₁=g^{r}^{₁}modP public. Each KRAᵢ selects a random polynomial f₁ε_{R}z_{q}[χ] of degree (t−1) such that f₁(0)=r₁. Let fᵢ(x)=rᵢ+a_{1,i}·x+a_{1,2}·x²+ . . . +a_{1,t-1}·x^{t-1}modq, where a_{i,1}, a_{1,2}, . . . , a_{1,t-1}ε_{R}z_{q}. Then the KRA₁ computes f₁(j)modq ∀j≈i, 1≦j≦n and sends it to the KRAⱼ securely.

Thereafter, each KRA₁ computes, g^{a}^{_{1,1}}modP, g^{a}^{_{1,2}}modP and makes them public. Using received fⱼ(i) ∀j≈i, 1≦j≦n , each KRAⱼ verifies if g^{f}^{_{J}}⁽¹⁾?yⱼ·(g^{a}^{_{J,1}})ⁱ_{₁}· . . . ·(g^{a}^{_{J,t-1}})^{J}_{ₜ₋₁}modP Vj≈i, 1≦j≦n.

Let us define H as the set {KRA₁|KRAᵢ is an honest KRA satisfying the previous step.} Each KRAᵢ computes its private key

$${X}_{i} = {\sum }_{j ∈ H} {f}_{j} ( i )$$

(i) and keeps it secure. The KRAs compute and publish their group public key

$$y = {\prod }_{j ∈ H} {y}_{j} .$$

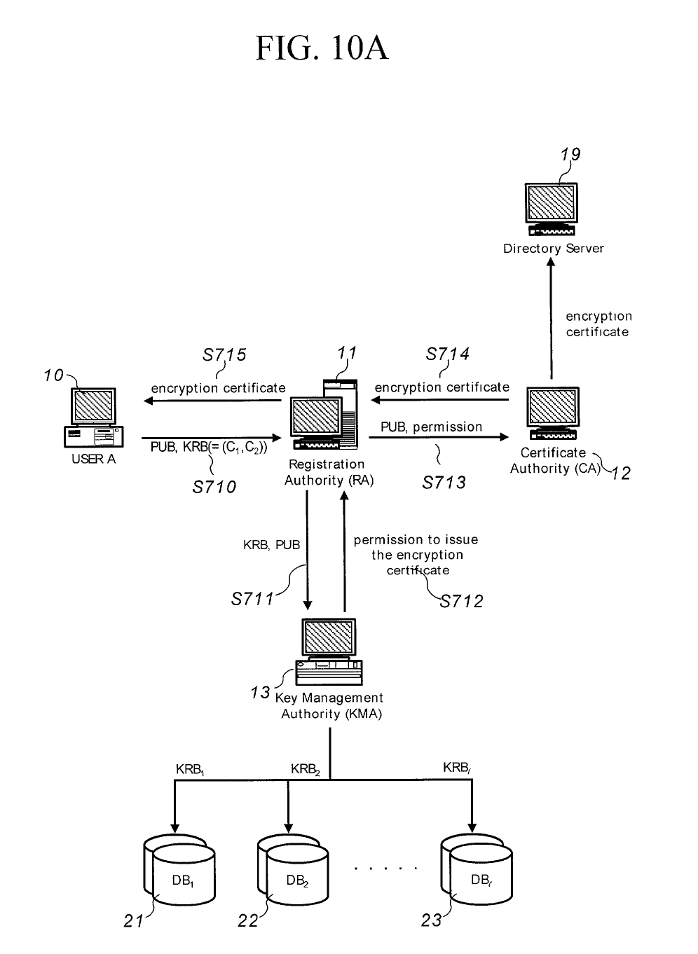

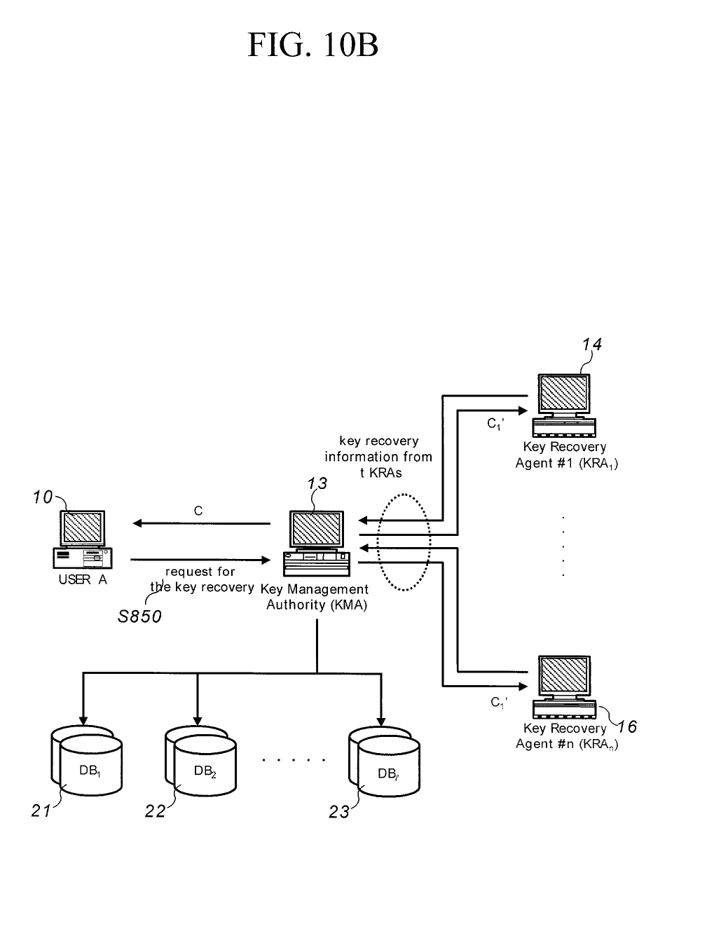

FIG. 10 is a schematic representation illustrating key generation, escrow process, and key recovery process of a seventh embodiment in accordance with the present invention, a (t, n)-commercial KES based on Diffie-Hellman.

Referring to FIG. 10A, the user 10 generates a pair of private/public keys (PRI, PUB), and sends the KRB along with the PUB to the RA 11 (step S710). The user 10 encrypts his private key, PRI, with his own password, PWD.

Thereafter, a random number z in the range of 0<z<q is selected. In addition, the key recovery block is computed from the following equation.

$$\begin{matrix}K R B = ( {C}_{1} , {C}_{2} ) \\ = ( {g}^{z} mod P , C \cdot {y}^{z} mod P )\end{matrix} \qquad ( 12 )$$

In the meanwhile, the RA 11 sends the key recovery block, KRB, and the public key, PUB, to the KMA 13 (step S711). The KMA 13 divides the KRB into l shares (KRB₁, KRB₂, . . . , KRBₗ) with(m, l)-SS (m<l), and stores each share with user's identifier in each database (DB₁, DB₂, . . . , DBₗ)

After the completion of the storage, the KRB is destroyed. The KMA 13 then sends a permission to issue the certificate of the encryption (step S712). The RA 11 then presents the permission to the CA 12 and requests a certificate for user's public key, PUB (step S713).

Accordingly, the CA 12 issues the certificate of encryption and makes it public at a directory server 19. The CA 12 sends the certificate to the RA 11 (step S714). Finally, the RA 11 forwards the certificate to the user 10 (step S715).

Referring to FIG. 10B, the user 10 sends a request for the key recovery to the KMA 13 (step S850). After identifying the user 10, the KMA 13 retrieves m key recovery blocks (KRB₁, KRB₂, . . . , KRBₘ) out of l key recovery blocks and reconstructs the KRB through the (m, l)-SS (m<l).

As a preferred embodiment in accordance with this invention, the encrypted private key E_{PWD}(PRI) can be recovered by the KMA 13 through the following steps. The KMA 13 randomly chooses a blind factor r (0<r<P−1) and calculates c₁′ from the relation of C₁′=C₁^{r}modP.

Thereafter, the KMA 13 sends the calculated C₁′ along with a request for the key recovery to the key recovery agents (KRA₁, KRA₂, . . . , KRAₙ).

In addition, each of t key recovery agents calculates C₁″₍ᵢ_{ⱼ}⁾=(C₁′)^{x}^{ₗⱼ} modP and then sends (C₁″₍ᵢ_{_{J}}⁾, i_{J}) to the KMA 13 (1≧ᵢ_{₁}< . . . <iᵢ_{ⱼ}< . . . <ᵢ_{ₜ}≧n) The KMA 13 receives t (C₁″₍₁₎, i) pairs from the KRAs of t, and recovers the encrypted private key C=E_{PWD}(PRI) by calculating

$${C}_{2} / {\prod }_{i} {( {C}_{1}^{{″}_{( i )}} )}^{{}^{{r}^{- 1}} {\prod }_{j \neq i} z / ( j - i )} mod P .$$

modP.

Finally, the KMA 13, which has a password verifier of the user 10, sends the recovered c=E_{PWD}(PRI) to the user in a secure fashion using “password-based private key downloading protocol”.

Now, when we want to apply the (t, n)-commercial KES based on Diffie-Hellman to a mandatory KES having a protection against a large-scale wiretapping, the RA performs an additional step of checking the validity of the escrowed key recovery block.

In this case, cut & choose method as in the previous second embodiment can be preferably employed.

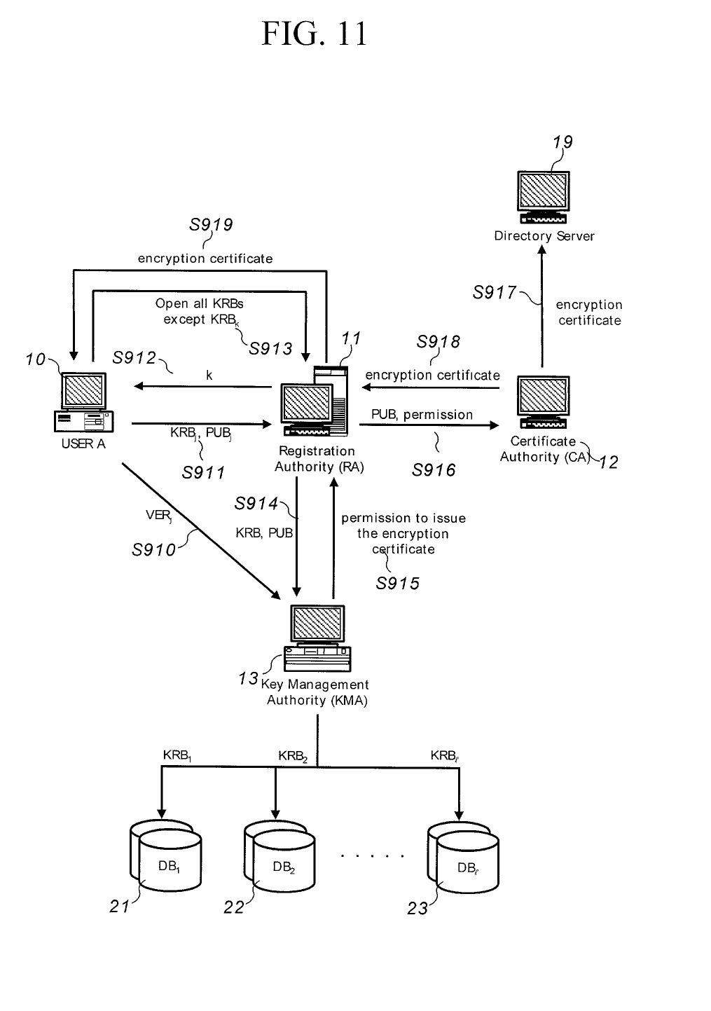

FIG. 11 is a schematic diagram illustrating the key generation and escrow process of an eighth embodiment in accordance with this invention, (t, n)-mandatory KES based on Diffie-Hellman.

Referring to FIG. 11, the user 10 generates a total of s passwords PWDⱼ (j=1, . . . , s) and registers the s password verifiers VERⱼ (j=1, . . . , s) corresponding to each password to the KMA 13 (step S910). Now, the user generates a total of s pairs of private/public keys for encryption (PRⱼ, PUBⱼ).

Thereafter, a set of KRBⱼ (j=1, . . . , s) is constructed and sent to the RA 11 along with PUBⱼ (j=1, . . . , s).

The private key PRIⱼ is encrypted with the password PWDⱼ of the user 10. In other words, C_{J}=E_{PWD}_{_{J}}(PRIⱼ) (j=1, . . . , s) is calculated. Preferably, in the key escrow system that needs the urgent wiretapping, the encrypting step with PWD can be skipped in the generating step of the KRB.

Additionally, a total of s random number zⱼ are chosen in the range of 0<z_{J}<q (j=1, . . . , s) and the KRBⱼ(j=1, . . . , s) is calculated from the following equation.

KRB_{J}=(C_{1J}, C₂ⱼ)=(g^{z}^{_{J}}modP, C_{J}·(y)^{z}_{_{J}}modP (13)

In the meanwhile, the RA 11 randomly chooses k in the range of 1≦k≦s and sends k to the user (step S912). Preferably, the security level of this system depends on the size of s.

Referring to FIG. 11 again, the user 10 opens (s−1) KRBⱼ except the KRBₖ to the RA 11 (step S913).

In other words, the PWDⱼ, PRIⱼ, and for ∀j≈k and 1≦j≦s are sent to the RA 11. Further, the RA 11, which has received (s−1) key recovery blocks except the KRBₖ, examines the validity of the KRBⱼ and the correspondence of PRIⱼ and PUBⱼ for ∀j≈k, 1≦j≦s.

As a preferred embodiment in accordance with this invention, this scheme can be designed in such a way as a non-interactive one with a hash function.

Now the RA 11 sends KRB=KRBₖ and PUB=PUBₖ to the KMA 13 (step S914). The remaining steps S915 through to S919 are identical to the processes of the fourth embodiment.

As a preferred embodiment for robust and practical (n, n)-mandatory KES based on Diffie-Hellman that is secure against the shadow public key attack, a sixth embodiment is disclosed wherein the private/public key of the user is generated and encrypted by the KMA and then sent to the user.

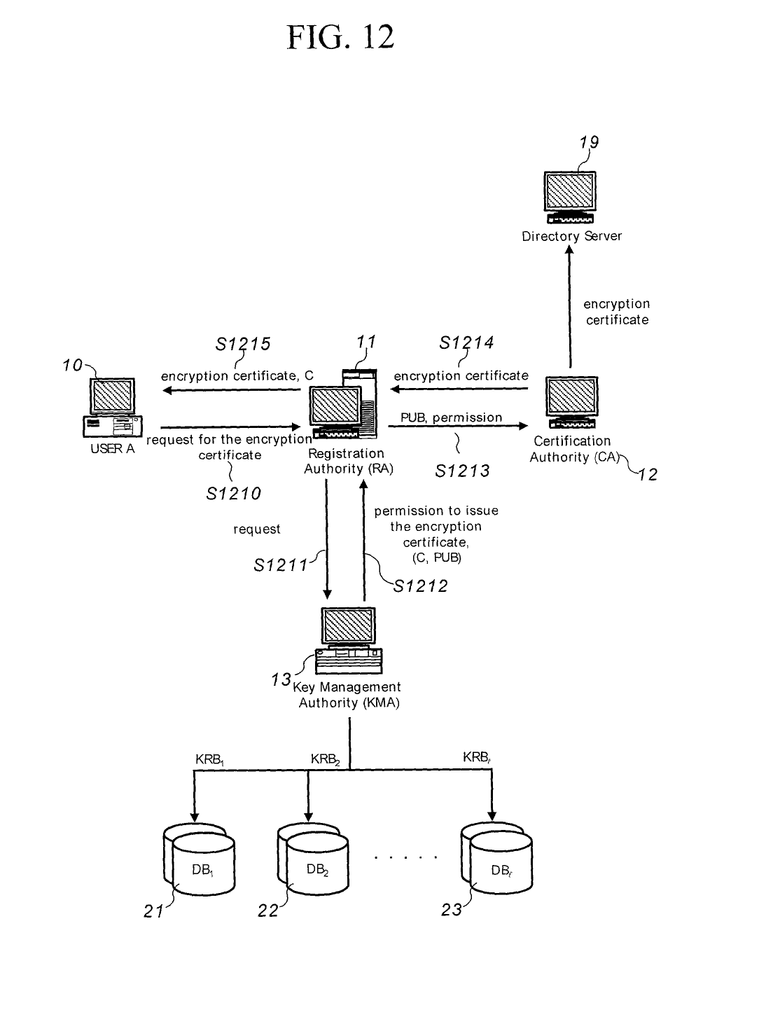

FIG. 12 is a schematic diagram illustrating the key generation and escrow process of a ninth embodiment in accordance with the present invention, (t, n)-mandatory KES based on Diffie-Hellman.

Referring to FIG. 12, the user 10 sends a request for the certificate of encryption to the RA 11 (step S1210). Then the RA 11 forwards the request to the KMA 13 (step S1211).

The KMA generates a pair of private/public keys (PRI, PUB) for the user, and constructs the KRB as illustrated in the following description.

The KMA 13 encrypts the private key of the user PRI with user's password PWD. In other words, C=E_{PWD}(PRI) is calculated. In this case, it is assumed that the password of the user PWD has already been registered in the KMA 13. Thereafter, the KMA 13 selects a random number z in the range of 0<z<q.

Moreover, the KMA 13 constructs the KRB from the following equation.

KRB=(C₁, C₂)=(g^{z}modP, C·y^{z}modp (14)

Additionally, the KMA divides the KRB into l shares (KRB₁, KRB₂, . . . , KRBₗ) with (m, l)-SS (m<l) and stores each share with user's identifier in each database (DB₁ 21, DB₂ 22, . . . , DBₗ 23). After, completing the storage, the KRB is destroyed.

The KMA 13 then sends a permission to issue the certificate of encryption along with (C, PUB) to the RA 11 (step S1212). The RA 11 then presents the permission to the CA 12 and requests a certificate for the public key of the user 10, PUB (step S1213).

Accordingly, the CA 12 issues the certificate of encryption and makes it public at a directory server 19. The CA 12 sends the certificate to the RA 11 (step S1214). Finally, the RA 11 forwards the certificate and C to the user 10 (step S1215).

For the eighth embodiment of this invention, the escrowed key can be recovered with the process illustrated in FIG. 10B. More preferably, the private key of the user, PRI, can be recovered by mounting a dictionary attack on the password of the user.

For the ninth embodiment of this invention, the escrowed key can also be recovered with the process illustrated in FIG. 10B. More preferably, the private key of the user, PRI, can be recovered with user's password that has been available with the KMA.

Although the present invention has been illustrated and described with respect to exemplary embodiments thereof, it should be understood by those skilled in the art that various other changes, omissions and additions may be made therein and thereto, without departing from the spirit and scope of the present invention.

It should be appreciated by those skilled in the art that the specific embodiments disclosed above may be readily utilized as a basis for modifying or designing other techniques and processes for carrying out the same purposes of the present invention.

It should also be realized by those skilled in the art that such equivalent constructions do not depart from the spirit and scope of the invention as set forth in the appended claims.

What is claimed is:

1. A method, under the PKI environment, of the key generation and escrow, comprising the steps of:
(a) having the user generate a password and register a password verifier of the user in a key management authority;
(b) having the user generate a pair of private/public keys;
(c) having the user encrypt his own private key with his own password (i.e.
C=E_{PWD} (PRI, where PWD is user's password and PRI is user's private key)
(d) having the user generate a key recovery block through encryption of the encrypted private key C with a public key of a key recovery agents.
(e) sending user's key recovery block and public key to the key management authority; and
(f) having the key management authority store the key recovery block, or divide it into several shares, followed by storing the shares separately.

2. A method, under the PKI environment, of the key generation and escrow, comprising the steps of:
(a) having the user generate a password and register a password verifier of the user in a key management authority;
(b) having the user generate a pair of private/public keys;
(c) having the user encrypt his own private key with his own password (i.e. C=E_{PWD} (PRI, where PWD is user's password and PRI is user's private key)
(d) having the user generate a key recovery block through encryption of the encrypted private key C with a public key of a key recovery agents.
(e) checking the validity of the key recovery block;
(f) sending user's validated key recovery block and public key to the key management authority;
(g) having the key management authority store the key recovery block, or divide it into several shares, followed by storing the shares separately.

3. The method as described in claim 2 wherein said step (c) is skipped and said step of (d) comprises a step of generating a key recovery block through the encryption of said user's private key with a public key of a key recovery agent by said user.

4. A method, under the PKI environment, of the key generation and escrow, comprising the steps of:
(a) having the user register his password in a key management authority(KMA);
(b) having the KMA generate a pair of private/public keys for the user;
(c) having the KMA encrypt the user's private key with the registered password of the user (i.e. C=E_{PWD} (PRI) where PWD:user's password, PRI:user's private key);
(d) having the KMA generate a key recovery block(KRB) through the encryption of said encrypted private key C with a public key of a key recovery agents (KRAs); and
(e) having the KMA either to store the KRB, or to divide the KRB into several shares, followed by separately storing said shares.

5. A method, under the PKI environment, of the key recovery, comprising the steps of:
(a) having a key management authority (KRA) construct a key recovery block (KRB) for the corresponding user upon the request for the key recovery;
(b) having the KMA to blind the constructed key recovery block by employing a blind factor of said key management authority's own so that any KRA is not able to see said constructed key recovery block;
(c) having the KMA to send the blinded key recovery block along with a request for the key recovery to KRAs;
(d) having each KRA perform a decryption of the message received by employing a private key of its own;
(e) having each KRA send the decrypted message processed at step (d) to said key management authority; and
(f) having the KMA recover a encrypted private key C of said user by employing the message received from each key recovery agent and said blind factor of its own.

6. The method as described in claim 5 wherein said request for the key recovery at step (a) is the request either from said user or from the court.

7. The method as described in claim 5 wherein less than all of shares of the corresponding user's key recovery block are required to construct the key recovery block.

8. The method as described in claim 5 wherein less than all of the messages received from key recovery agents are required to recover the encrypted private key for the corresponding user.

9. The method as described in claim 5 further includes a step of having a key management authority send said recovered C to the key recovery requestor using the password-based private key downloading protocol.

10. The method as described in claim 5 wherein a key management authority or a trusted entity recovers the user's private key for encryption from C by mounting a dictionary attack.

11. The method as described in claim 5 wherein a key management authority or a trusted entity recovers the user's private key for encryption with the user's registered passwords.

12. A key escrow system for the PKI environment comprising:
a user who generates his own password, registers his own password verifier in a key management authority (KMA), generates a pair of private/public key pairs (PRI, PUB) , encrypts his private key with said password (C=E_{PWD} (PRI), and generates a key recovery block (KRB) through encrypting C with a public key of key recovery agents (KRAs)
a KMA that stores either said KRB or the divided shares of said KRB in a distributed manner, constructs said KRB from the divided shares at a key recovery phase, sends to KRAs a request for the key recovery along with a blinded KRB which is a multiplication of said KRB with a blind factor in order not to disclose said KRB to any of said KRAs, and recovers C with received messages from said KRAs and with said blind factor; and
KRAs that decrypt message sent from said KMA with the private key of their owns.

13. The key escrow system as described in claim 12 wherein said KRB generated by said user is checked for the validity.

14. A key escrow system for PKI environment comprising:
a user who registers his password (PWD) in a key management authority (KMA), comprising:
a KMA that generates a pair of private/public keys (PRI, PUB) for said user, encrypts said user's private key with said user's registered password (C=E_{PWD} (PRI) generates a key recovery block (KRB) through encrypting C with the public key of the key recovery agents (KRAs), stores said KRB or the divided shares of said KRB in a distributed manner, reconstructs said KRB out of said divided shares upon the request for recovery, sends to KRAs a request for recovery along with a blinded KRB which is a multiplication of said KRB with a blind factor in order not to disclose said KRB to any of said KRAs, and recovers C with received messages for said KRAs and with said blind factor; and
KRAs that decrypt messages sent from said KMA with private keys of their own.

15. The key escrow system as described in claim 12 or claim 14 wherein less than all of shares of the corresponding user's key recovery block are required to construct the key recovery block.

16. The key escrow system as described in claim 12 or claim 14 wherein less than all of the messages received from key recovery agents are required to recover the encrypted private key for the corresponding user.
